(19) United States
(12) Patent Application Publication
(10) Pub. No.: US 2007/0044664 A1
(43) Pub. Date: Mar. 1, 2007

(54) Automatic Coffee Maker And Control Method Thereof

(76) Inventor: Dong-lei WANG, Zuhai City (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/466,191

(22) Filed: Aug. 22, 2006

(30) Foreign Application Priority Data
Aug. 25, 2005 (CN) 200510036683.7

(51) Int. Cl. A47J 31/44

(52) U.S. Cl. 99/279

(57) ABSTRACT

The present invention provides an automatic coffee maker, which is compact and safe. In use of the automatic coffee maker, under the control of the control circuit, prior to heating, the pump is started to make certain cold water flow into the boiler, so as to prevent the temperature sensor or temperature fuse from damage by heating. Therefore, the safety performance and the operation performance of the automatic coffee maker of the present invention are greatly improved.

### CROSS-REFERENCE TO RELATED APPLICATION

This application claims priority of CN Patent Application No. 200510036683.7 filed on Aug. 25, 2005, entitled “Control Method for A Coffee Maker and the Coffee Maker” which is incorporated herein by reference for all purposes.

### TECHNICAL FIELD

The present invention relates to an automatic coffee maker and control method thereof.

### BACKGROUND OF THE INVENTION

In an existing automatic coffee maker, a control program is set in the control circuit of the machine. Under the control of the control circuit, a boiler is heated first, then cold water from a reservoir enters the boiler via a pump, and hot water from the boiler enters a brewing chamber for brewing coffee. Therefore, in start-up or during operation of the automatic coffee maker, if there is no water inside the boiler or the water level is too low, risk of dry heating for the heater may arise, which may cause damage of the temperature sensor or temperature fuse. If a small size boiler is used, it is always difficult to meet safety requirements due to the higher local temperature required, therefore, in existing automatic coffee makers, a large size boiler is usually adopted. However, if a large size boiler is used, it will increase the size of the whole coffee maker, without solving the safety problem satisfactory either.

### SUMMARY OF THE INVENTION

The primary object of the present invention is to provide an automatic coffee maker, which is compact and safe, and the control method thereof.

In accordance with the present invention, an automatic coffee maker is provided, comprising: a casing, a reservoir, a pump, a boiler assembly, a brewing chamber and a control circuit; wherein said control circuit comprises a control chip, and connected with said control chip are sampling circuit for thermal sensors, control circuit for the pump and control circuit for the heater.

Wherein said boiler assembly comprises:

a boiler having a shell with an inlet for cold water and an outlet for hot water;

a heater installed inside said boiler shell;

at least one temperature fuse installed adjacent said heater, which will cut off the heater in case of a shutdown of the circuit so as to clear the danger;

a temperature sensor passing through said boiler shell, wherein the contact head of the temperature sensor is disposed inside said boiler shell, the remaining part of the temperature sensor is disposed outside said boiler shell, and wherein said temperature sensor can send out temperature signals to said control circuit.

Wherein, said boiler shell has at least one inwardly protruding hollow adjacent said heater for accommodating said at least one temperature fuse outside said boiler shell.

Wherein, said boiler assembly may comprise a flow meter, which is installed on the water flow path toward the boiler; wherein said control circuit further comprises a detection circuit for the flow meter so as to send out flow signals to said control chip connected with said detection circuit.

Wherein, said boiler assembly may comprise an alarm, which can send out alarms under the control of said control circuit.

Wherein, control procedure for brewing coffee is programmed in said control chip, which comprises following steps:

prior to heating, the pump is started to make certain cold water flow into the boiler, so as to prevent the temperature sensor or temperature fuse from damage by heating;

after a preset time period has passed, the heater is energized to give heat;

the pump keeps running to allow certain cold water flow into the boiler for heating;

after a preset time period has passed, the pump is stopped;

the heater works under the control of the control chip in response to the signals from the thermal sensors;

during a certain period approaching the end of coffee brewing, energizing the heater at intervals, so that hot water within the boiler will completely change into steam, and the fact that only steam passing around the coffee pod in the brewing chamber will effect to bake the coffee pod and prevent it from dripping.

Wherein, following optional steps may be further included:

during coffee brewing, if the temperature inside the boiler is not up to a set value within a preset time period, an alarm signal is sent out and the heater is cut off;

in case the flow meter runs slow or does not run at all within a preset period, an alarm signal is sent out and the heater is cut off.

The present invention can prevent the coffee maker from dry heating, from brewing below a preset temperature, and prevent the coffee pods disposed inside the brewing chamber from dripping. With the present invention, it is easy to discover the failures of the flow meter. Therefore, the safety performance and the operation performance of the automatic coffee maker of the present invention are greatly improved.

### BRIEF DESCRIPTION OF THE DRAWINGS

Further features and advantages of the present invention will become apparent from the following detailed description, taken in combination with the appended drawings, in which:

FIG. 1 is a partial schematic view of the automatic coffee maker in accordance with one embodiment of the present invention;

FIG. 2 is a schematic view of the boiler assembly of the automatic coffee maker in accordance with one embodiment of the present invention;

FIG. 3 is a cross-sectional view of the boiler assembly along A-A line of FIG. 2;

FIG. 4 is a cross-sectional view of the boiler assembly along B-B line of FIG. 2;

FIG. 5 is a block diagram of the control circuit of the automatic coffee maker as shown in FIG. 1;

FIG. 6 is a connection diagram of the control circuit as shown in FIG. 5.

### DETAILED DESCRIPTION OF THE PREFERRED EMBODIMENT

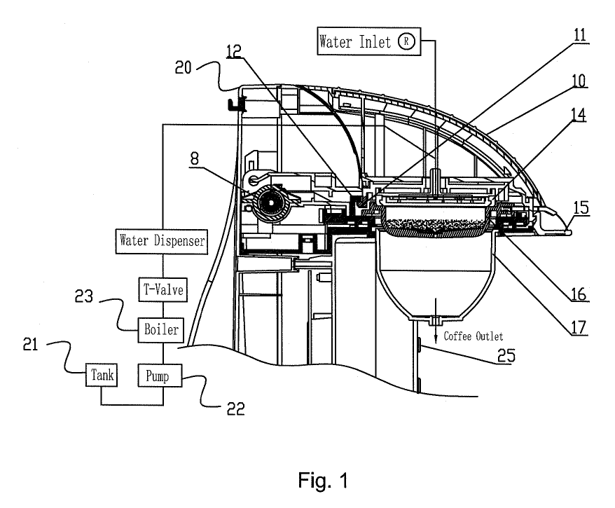

As shown in FIG. 1, according to one embodiment of the present invention, an automatic coffee maker comprises a body 20, a reservoir 21, an electro-magnetic pump 22, a boiler assembly 23, a brewing chamber 17, a top cover 10 and a control circuit activated by switches 25. The top cover 10 is connected on the top of the coffee maker body 20 via the pivot axis 8, whereby the top cover 10 is rotatable about the pivot axis, enabling the opening and closing of the top cover 10 of the coffee maker with an open button 15. A brewing chamber cover is fixed at the bottom of the top cover 10. A sealing ring 14 is installed at the periphery of the brewing chamber cover, so that, when the brewing chamber cover is engaged with the brewing chamber seat 12, the sealing ring 14 is accommodated at the inner side of the periphery of the brewing chamber seat 12. At the periphery of the brewing chamber cover, outside the sealing ring 14, several locking pins 11 are installed at an equal distance span, e.g. three locking pins 11 may be provided, each spaced 120° apart. The locking pins 11 may be formed integrally with the brewing chamber cover. The brewing chamber 17 is fixed in the coffee maker body under the top cover 10. A moveable brewing chamber installation 16 may be further disposed inside the brewing chamber body 17, so that, different brewing chamber installations for different purposes may be installed and changed based on desires, such as for brewing coffee, for brewing tea, etc.

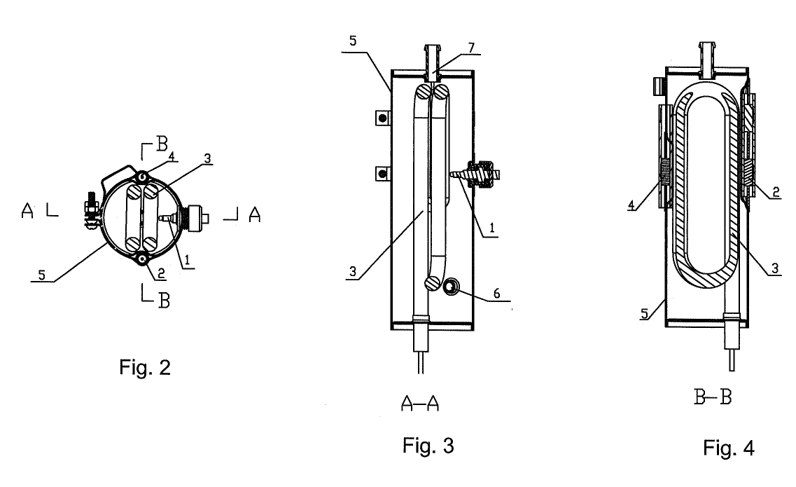

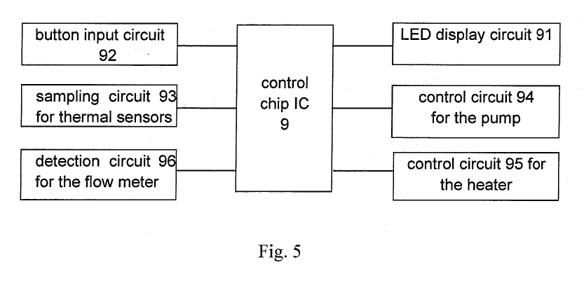

As shown in FIGS. 2, 3 and 4, the boiler assembly 23 comprises a boiler, an electric heater 3, two temperature fuses 2 and 4, a temperature sensor 1 and a flow meter.

The boiler has a shell 5, which may be made of stainless steel and has an inlet 6 for cold water and an outlet 7 for hot water. The boiler shell 5 is in the shape of a cylinder. The electric heater 3 is installed inside the boiler shell 5. Two temperature fuses 2, 4 are installed adjacent the heater 3, and the boiler shell 5 has two opposite inwardly protruding hollows adjacent the electric heater 3 for accommodating the two temperature fuses 2, 4 outside the boiler shell 5. Thereby, once the temperature inside the boiler shell 5 is too high, either of the two temperature fuses 2, 4 can cut off the heater in case of a shutdown of the circuit so as to clear the danger. A temperature sensor 1 passes through the boiler shell 5, wherein the contact head of the temperature sensor 1 is disposed inside the boiler shell 5, the remaining part of the temperature sensor 1 is disposed outside the boiler shell 5. The temperature sensor 1 can send out temperature signals to the control circuit. A flow meter is installed on the water flow path toward the boiler for measuring flow level and sending out flow signals to said control circuit. An alarm is further provided for sending out alarms under the control of said control circuit.

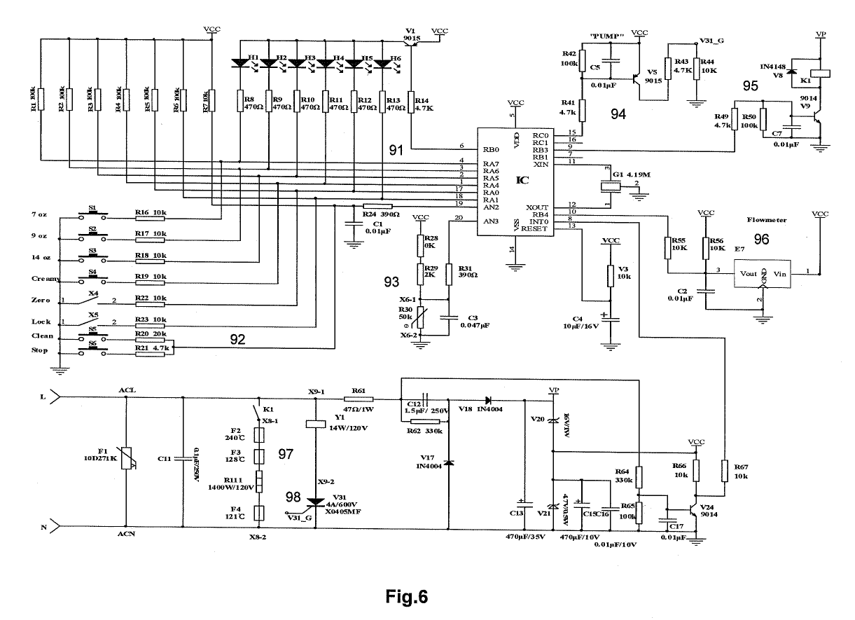

As shown in FIGS. 5 and 6, said control circuit comprises a control chip IC 9, and connected with the control chip IC 9 are LED display circuit 91, button input circuit 92, sampling circuit 93 for thermal sensors, control circuit 94 for the electro-magnetic pump 22, control circuit 95 for the heater 3 and detection circuit 96 for the flow meter.

When one of the LEDs lights, the corresponding leg of the IC 9 will have an output of a low voltage level, indicating a certain working status of the coffee maker.

When one of the buttons of the button input circuit 92 is pressed down, the corresponding leg of the IC 9 will have an input of a high voltage level or a constant voltage level instead of the low voltage level, and the IC will execute a corresponding procedure.

When the temperature of the boiler is increased or decreased, the resistance of the thermistor R30 of the sampling circuit 93 will decrease or increase, and the sampling values after A/D conversion will be decreased or increased correspondingly, in response to which the IC 9 will control the energizing or de-energizing of the heater 3.

When it is necessary to start the pump 22, the RC0 leg of the IC 9, which is connected with the control circuit 94 for the pump 22, will output a high level instead of a low level, the transistor V5 is conducting, the thyristor (SCR) V31 in the circuit 98 is conducting with its G terminal energized, and the electro-magnetic pump Y1 is started.

When the temperature of the boiler is lower than a set value, the RB3 terminal of the IC 9, which is connected with the control circuit 95 for the heater 3, will output a high level instead of a low level, the transistor V9 is conducting, the relay K1 is closed, the heater R111 in the circuit 97 is conducting, and the boiler is heated. On the contrary, when the temperature of the boiler is higher than a set value, the heater will be de-energized. After a preset time period has passed, since the temperature inside the boiler goes above a set value, the water inside the boiler will turn into steam, and the steam will eject from the outlet of the boiler.

When water flows through the flow meter, the impeller equipped with a magnet rotates, the Hall element E7 of the detection circuit 96 for the flow meter detects the change of the signals and outputs a high or a low voltage level correspondingly. The signals are input into the control chip IC 9 for processing, so that the flow is measured. If there is no water flow, the impeller will not rotate or rotate very slowly, and the pulse width of the corresponding input voltage will be rather large.

The control procedure for brewing coffee is programmed in said control chip, which comprises following steps:

prior to heating, the pump is started to make certain cold water flow into the boiler, so as to prevent the temperature sensor or temperature fuse from damage by heating;

after a preset time period has passed, the heater is energized to give heat;

the pump keeps running to allow certain cold water flow into the boiler for heating;

after a preset time period has passed, the pump is stopped;

the heater works under the control of the control chip in response to the signals from the thermal sensors;

during a certain period approaching the end of coffee brewing, energizing the heater at intervals, so that hot water within the boiler will completely change into steam, and the fact that only steam passes around the coffee pod will effect to bake the coffee pod and prevent it from dripping.

Following optional steps may be further included separately or in combination:

during coffee brewing, if the temperature inside the boiler is not up to a set value within a preset time period, an alarm signal is sent out and the heater is cut off;

in case the flow meter runs slow or does not run at all within a preset period, an alarm signal is sent out and the heater is cut off.

What is claimed is:

1. An automatic coffee maker comprising: a casing, a pump, a reservoir, a boiler assembly, a brewing chamber and a control circuit; wherein said control circuit comprises a control chip, and connected with said control chip are sampling circuit for thermal sensors, control circuit for the pump and control circuit for the heater; wherein said boiler assembly comprises:
a boiler having a shell with an inlet for cold water and an outlet for hot water;
a heater installed inside said boiler shell;
at least one temperature fuse installed adjacent said heater, which will cut off the heater in case of a shutdown of the circuit so as to clear the danger;
a temperature sensor passing through said boiler shell, wherein the contact head of the temperature sensor is disposed inside said boiler shell, the remaining part of the temperature sensor is disposed outside said boiler shell, and wherein said temperature sensor can send out temperature signals to said control circuit.

2. An automatic coffee maker according to claim 1, wherein said boiler shell has at least one inwardly protruding hollow adjacent said heater for accommodating said at least one temperature fuse outside said boiler shell.

3. An automatic coffee maker according to claim 1, wherein said boiler assembly comprises a flow meter which is installed on the water flow path toward the boiler; wherein said control circuit further comprises a detection circuit for the flow meter so as to send out flow signals to said control chip connected with said detection circuit.

4. An automatic coffee maker according to claim 2, wherein said boiler assembly comprises a flow meter which is installed on the water flow path toward the boiler; wherein said control circuit further comprises a detection circuit for the flow meter so as to send out flow signals to said control chip connected with said detection circuit.

5. An automatic coffee maker according to claim 1, wherein said boiler assembly comprises an alarm for sending out an alarm under the control of said control circuit.

6. An automatic coffee maker according to claim 2, wherein said boiler assembly comprises an alarm for sending out an alarm under the control of said control circuit.

7. An automatic coffee maker according to claim 3, wherein said boiler assembly comprises an alarm for sending out an alarm under the control of said control circuit.

8. An automatic coffee maker according to claim 1, wherein a control procedure for brewing coffee is programmed in said control chip, which comprises following steps:
prior to heating, the pump is started to make certain cold water flow into the boiler, so as to prevent the temperature sensor or temperature fuse from damage by heating;
after a preset time period has passed, the heater is energized to give heat;
the pump keeps running to allow certain cold water flow into the boiler for heating;
after a preset time period has passed, the pump is stopped;
the heater works under the control of the control chip in response to the signals from the thermal sensors;
during a certain period approaching the end of coffee brewing, energizing the heater at intervals, so that hot water within the boiler will completely change into steam, and the fact that only steam passes around the coffee pod will effect to bake the coffee pod and prevent it from dripping.

9. An automatic coffee maker according to claim 2, wherein a control procedure for brewing coffee is programmed in said control chip, which comprises following steps:
prior to heating, the pump is started to make certain cold water flow into the boiler, so as to prevent the temperature sensor or temperature fuse from damage by heating;
after a preset time period has passed, the heater is energized to give heat;
the pump keeps running to allow certain cold water flow into the boiler for heating;
after a preset time period has passed, the pump is stopped;
the heater works under the control of the control chip in response to the signals from the thermal sensors;
during a certain period approaching the end of coffee brewing, energizing the heater at intervals, so that hot water within the boiler will completely change into steam, and the fact that only steam passes around the coffee pod will effect to bake the coffee pod and prevent it from dripping.

10. An automatic coffee maker according to claim 3, wherein a control procedure for brewing coffee is programmed in said control chip, which comprises following steps:
prior to heating, the pump is started to make certain cold water flow into the boiler, so as to prevent the temperature sensor or temperature fuse from damage by heating;
after a preset time period has passed, the heater is energized to give heat;
the pump keeps running to allow certain cold water flow into the boiler for heating;
after a preset time period has passed, the pump is stopped;
the heater works under the control of the control chip in response to the signals from the thermal sensors;
during a certain period approaching the end of coffee brewing, energizing the heater at intervals, so that hot water within the boiler will completely change into steam, and the fact that only steam passes around the coffee pod will effect to bake the coffee pod and prevent it from dripping.

11. A control method for controlling the automatic coffee maker as claimed in claim 1, wherein a control procedure for brewing coffee is programmed in said control chip, which comprises following steps:
prior to heating, the pump is started to make certain cold water flow into the boiler, so as to prevent the temperature sensor or temperature fuse from damage by heating;
after a preset time period has passed, the heater is energized to give heat;
the pump keeps running to allow certain cold water flow into the boiler for heating;
after a preset time period has passed, the pump is stopped;
the heater works under the control of the control chip in response to the signals from the thermal sensors;
during a certain period approaching the end of coffee brewing, energizing the heater at intervals, so that hot water within the boiler will completely change into steam, and the fact that only steam passes around the coffee pod will effect to bake the coffee pod and prevent it from dripping.

12. A control method for controlling the automatic coffee maker as claimed in claim 11, wherein said boiler assembly comprises an alarm for sending out an alarm under the control of said control circuit; and wherein during coffee brewing, if the temperature inside the boiler is not up to a set value within a preset time period, an alarm signal is sent out and the heater is cut off.

13. A control method for controlling the automatic coffee maker as claimed in claim 11, wherein said boiler assembly comprises a flow meter which is installed on the water flow path toward the boiler and an alarm for sending out an alarm under the control of said control circuit; wherein said control circuit further comprises a detection circuit for the flow meter so as to send out flow signals to said control chip connected with said detection circuit; and wherein in case the flow meter runs slow or does not run at all within a preset period, an alarm signal is sent out and the heater is cut off.

14. A control method for controlling the automatic coffee maker as claimed in claim 12, wherein said boiler assembly comprises a flow meter which is installed on the water flow path toward the boiler and said control circuit further comprises a detection circuit for the flow meter so as to send out flow signals to said control chip connected with said detection circuit; and wherein in case the flow meter runs slow or does not run at all within a preset period, an alarm signal is sent out and the heater is cut off.
